(19) United States
(12) Patent Application Publication
(10) Pub. No.: US 2026/0209005 A1
(43) Pub. Date: Jul. 23, 2026

(54) ACTIVATION AND/OR DEACTIVATION OF A TEMPORARY REFUGE SPACE

(71) Applicant: KONE Corporation, Helsinki (FI)

(72) Inventors: Juha-Matti AITAMURTO, Helsinki (FI); Ari KATTAINEN, Helsinki (FI)

(73) Assignee: KONE Corporation, Helsinki (FI)

(21) Appl. No.: 19/570,712

(22) Filed: Mar. 18, 2026

Related U.S. Application Data
(63) Continuation of application No. PCT/EP2023/074303, filed on Sep. 5, 2023.

(51) Int. Cl. B66B 5/00

(52) U.S. Cl. CPC B66B 5/0056

(57) ABSTRACT

According to an aspect, there is provided a system for activating and/or deactivating a temporary refuge space in an elevator shaft. With described solution it is possible to remove the risks related to crushing person in working areas in elevator shaft while still enabling a controlled movement of the elevator car.

### TECHNICAL FIELD

The disclosure relates to elevator systems, and more particularly to a solution for activating and/or deactivating a temporary refuge space in an elevator shaft.

### BACKGROUND

When entering an elevator shaft and performing, for example, maintenance operations, one of the main risks for a person in the elevator shaft is the risk of crushing. The risk of crushing is present both when the person is on the elevator car roof and in the pit. For example, the elevator car may move close to the elevator shaft ceiling and there is no sufficient space for the person, or the elevator car or a counterweight may move close to the pit and there is no sufficient space for the person.

In order to provide a sufficient refuge space for the person in the elevator shaft, it is possible, for example, to dimension the pit depth and the headroom height such that there is a permanent and sufficient refuge space above and/or below the elevator car trajectory. This, however, requires extended depth/height for the elevator shaft, which may increase construction costs and other costs of the built space, or it may be inconvenient from an architectural point of view.

It is also possible to use technical measures to form a refuge space in the shaft. The elevator norm EN 81-21 recognizes two different solutions for creating artificial (non-permanent) refuge space, “movable stops” (for example, a turnable buffer) and “pre-triggered stopping system” (for example, a safety-gear triggering device, which is located at a fixed triggering point in an elevator shaft). These solutions, however, do not prevent the presence of the persons in the hazard zone even when the technical means are not active.

The risk of crushing may also be removed completely. This can be achieved, when access to the hazard zone to the elevator shaft where the crushing risk exists, is not possible. For example, an elevator car may have an erectable car roof or removable car floor or car wall parts, such that elevator maintenance in elevator shaft can be carried out from inside of the elevator car without entering the shaft. These solutions, however, are complicated and/or expensive to implement.

### SUMMARY

It is an objective to provide a solution for activating and/or deactivating a temporary refuge space in an elevator shaft. The objective is achieved by the features of the independent claims. Some embodiments are described in the dependent claims.

According to a first aspect, there is provided a system for activating a temporary refuge space in an elevator shaft. The system comprises elevator shaft access locking means for controlling access to the temporary refuge space via an elevator shaft access, the elevator shaft access locking means having a locked state in which opening of the elevator shaft access to the temporary refuge space is prevented and an unlocked state in which opening of the elevator shaft access to the temporary refuge space is allowed; movement prohibiting means for prohibiting movement of an elevator car in the elevator shaft, the movement prohibiting means being operable between an inactive state in which the movement of the elevator car is enabled throughout its operating range and an active state in which the movement of the elevator car into the temporary refuge space is prevented; and refuge space control means associated with the elevator shaft access locking means and the movement prohibiting means. The refuge space control means are configured to, in response to determining a temporary refuge space activation request, change the state of the movement prohibiting means to the active state, and in response to changing the state of the movement prohibiting means to the active state, cause a change of the state of the elevator shaft access locking means to the unlocked state to enable access to the temporary refuge space in the elevator shaft via the elevator shaft access.

In an implementation form of the first aspect, the refuge space control means are configured to determine the temporary refuge space activation request based on a signal from manual operating means.

In an implementation form of the first aspect, the refuge space control means are configured to receive the temporary refuge space activation request via a communication connection.

In an implementation form of the first aspect, the refuge space control means are configured to reveal hidden manual operating means associated with a landing in response to receiving the temporary refuge space activation request; receive a signal from the manual operating means, the signal resulting from an action on the manual operating means by a person at a landing; and change the state of the movement prohibiting means to the active state in response to receiving the signal.

In an implementation form of the first aspect, the refuge space control means are configured to start a timer in response to receiving the temporary refuge space activation request; and change the state of the movement prohibiting means to the active state in response to receiving the signal only when receiving the signal before the timer has expired.

In an implementation form of the first aspect, the system further comprises a short-range wireless reader arranged at a landing and configured to receive identification data provided by a person at the landing. The the refuge space control means are configured to determine the temporary refuge space activation request based on the identification data from the short-range wireless reader.

In an implementation form of the first aspect, the movement prohibiting means are selectively movable between a retracted position to provide the inactive state and a blocking position to provide the active state.

In an implementation form of the first aspect, the movement prohibiting means are mechanically connected to the elevator shaft access locking means such that when the state of the movement prohibiting means changes to the active state, the mechanical connection causes the change of the state of the elevator shaft access locking means to the unlocked state.

In an implementation form of the first aspect, the movement prohibiting means are electrically connected to the elevator shaft access locking means such that when the state of the movement prohibiting means changes to the active state, the mechanical connection causes the change of the state of the elevator shaft access locking means to the unlocked state.

In an implementation form of the first aspect, the temporary refuge space is located in the pit of the elevator shaft.

In an implementation form of the first aspect, the temporary refuge space is located at the roof of the elevator car.

In an implementation form of the first aspect, the refuge space control means are configured to allow a low-speed elevator operation, for example, 0.63 or 0.3 m/s in the active state of the movement prohibiting means.

According to a second aspect, there is provided a system for deactivating an activated temporary refuge space in an elevator shaft. The system comprises elevator shaft access locking means for controlling access to the temporary refuge space via an elevator shaft access, the elevator shaft access locking means having a locked state in which opening of the elevator shaft access to the temporary refuge space is prevented and an unlocked state in which opening of the elevator shaft access to the temporary refuge space is allowed, wherein when the temporary refuge space is activated, the elevator shaft access locking means are in the unlocked state; movement prohibiting means for prohibiting movement of an elevator car in the elevator shaft, the movement prohibiting means being operable between an inactive state in which the movement of the elevator car is enabled throughout its operating range and an active state in which the movement of the elevator car into the temporary refuge space is prevented, wherein when the temporary refuge space is activated, the movement prohibiting means are in the active state; refuge space deactivation means for providing deactivation information associated with the temporary refuge space; and refuge space control means associated with the elevator shaft access locking means, the movement prohibiting means and refuge space deactivation means. The refuge space control means are configured to receive refuge space deactivation information from the refuge space deactivation means; determine that the elevator shaft access is closed; change the state of the elevator shaft access locking means to the locked state; cause a change of the state of the movement prohibiting means to the inactive state; and generate a signal indicating that the temporary refuge space has been deactivated.

In an implementation form of the second aspect, the deactivation information associated with the temporary refuge space comprises information about the presence of the person in the temporary refuge space. The refuge space control means are configured to determine, based the refuge space deactivation information, that the temporary refuge space is empty.

In an implementation form of the second aspect, the refuge space monitoring means comprises at least one of a camera, an infrared sensor and a pressure mat arranged in the temporary refuge space for indicating the presence or absence of the person in the temporary refuge space.

In an implementation form of the second aspect, the refuge space deactivation means comprises a first control function associated with the temporary refuge space and a second control function associated with the outside the elevator shaft. The refuge space control means are configured to receive first temporary refuge space deactivation information from the first control function, the first temporary refuge space deactivation information initiating the deactivation of the temporary refuge space; and receive second temporary refuge space deactivation information from the second control function, the second temporary refuge space deactivation information confirming the deactivation of the temporary refuge space.

In an implementation form of the second aspect, the refuge space control means are configured to start a timer in response to receiving the first temporary refuge space deactivation information; determine, whether the second temporary refuge space deactivation information is received before the timer expires; and generate the signal indicating that the temporary refuge space has been deactivated only, when the second temporary refuge space deactivation information is received before the timer expires.

In an implementation form of the second aspect, the refuge space deactivation means comprises a first control function associated with the temporary refuge space and a second control function associated with the outside the elevator shaft. The refuge space control means are configured to receive first temporary refuge space deactivation information from the second control function, the first temporary refuge space deactivation information initiating the deactivation of the temporary refuge space; receive second temporary refuge space deactivation information from the first control function; and determine, based on the second temporary refuge space deactivation information, that the temporary refuge space is empty.

In an implementation form of the second aspect, the first control function comprises at least one of the following: a manually operable control element configured to enable a manual operation performed by a person; a short-range wireless reader configured to receive identification data provided by the person at the temporary refuge space; a camera configured to provide an indication of the absence of the person in the temporary refuge space; an infrared sensor configured to provide an indication of the absence of the person in the temporary refuge space; and a pressure sensor configured to provide an indication of the absence of the person in the temporary refuge space.

In an implementation form of the second aspect, the second control function comprises at least one of the following: a manually operable control element configured to enable a manual operation performed by a person at a landing; a short-range wireless reader configured to receive identification data provided by the person at the landing; a camera based recognition system; and a camera based reader configured to read identification data provided by the person at the landing.

In an implementation form of the second aspect, the movement prohibiting means are mechanically connected to the elevator shaft access locking means such that when the state of the movement prohibiting means changes to the inactive state, the mechanical connection causes the change of the state of the elevator shaft access locking means to the locked state.

In an implementation form of the second aspect, the movement prohibiting means are electrically connected to the elevator shaft access locking means such that when the state of the movement prohibiting means changes to the inactive state, the electrical connection causes the change of the state of the elevator shaft access locking means to the locked state.

According to a third aspect, there is provided an elevator system. The elevator system comprises an elevator car disposed in and movable in an elevator shaft; and a system of the first and/or second aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates a system according to an example embodiment.

FIG. 1B illustrates a system according to another example embodiment.

FIG. 1C illustrates a system according to another example embodiment.

FIG. 1D illustrates an elevator system according to another example embodiment.

### DETAILED DESCRIPTION

According to the solution presented in the description below, a solution for activating and/or deactivating a temporary refuge space in an elevator shaft is provided. The solution is advantageous as it is possible to remove the risks relating to crushing a person or persons working in the elevator shaft.

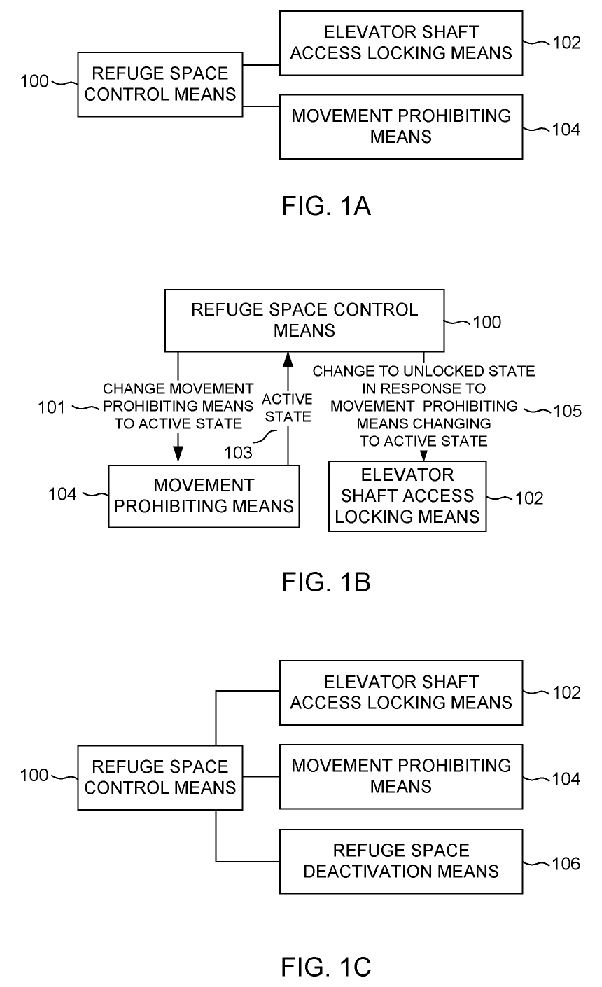

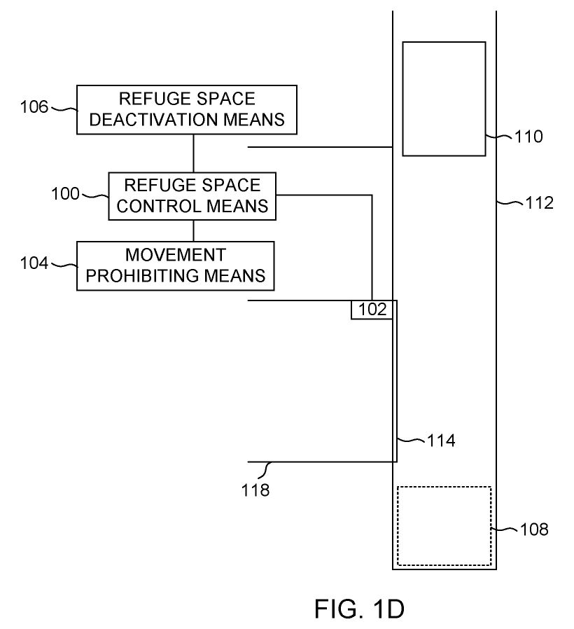

FIG. 1A illustrates a block diagram of a system for activating a temporary refuge space in an elevator shaft according to an example embodiment.

The system comprises elevator shaft access locking means 102 for controlling access to the temporary refuge space via an elevator shaft access, the elevator shaft access locking means 102 having a locked state in which opening of the elevator shaft access to the temporary refuge space is prevented and an unlocked state in which opening of the elevator shaft access to the temporary refuge space is allowed. The elevator shaft access may refer, for example, to an elevator landing door or doors. The system further comprises movement prohibiting means 104 for prohibiting movement of an elevator car in the elevator shaft, the movement prohibiting means 104 being operable between an inactive state in which the movement of the elevator car 110 is enabled throughout its operating range and an active state in which the movement of the elevator car into the temporary refuge space is prevented. The elevator shaft access locking means 102 may refer, for example, to a lock whose locking state can be remotely controlled.

The system further comprises refuge space control means 100 associated with the elevator shaft access locking means 102 and the and the movement prohibiting means 104. The refuge space control means 100 may be configured to, in response to determining a temporary refuge space activation request, change the state of the movement prohibiting means 104 to the active state and cause a change of the state of the elevator shaft access locking means 102 to the unlocked state to enable access to the temporary refuge space in the elevator shaft via the elevator shaft access. In an example embodiment, the movement prohibiting means 104 may be electrically connected to the elevator shaft access locking means 102 such that when the state of the movement prohibiting means 104 changes to the active state, the electrical connection causes the change of the state of the elevator shaft access locking means 102 to the unlocked state. In another example embodiment, the movement prohibiting means 104 may be mechanically connected, for example, via a connecting rod or lever, to the elevator shaft access locking means 102 such that when the state of the movement prohibiting means 104 changes to the active state, the mechanical connection causes the change of the state of the elevator shaft access locking means 102 to the unlocked state. The refuge space control means 100 may refer, for example, to hardware and/or software elements implementing the functionality relating to the refuge space control means 100.

In an example embodiment, the refuge space control means 100 may be configured to determine the temporary refuge space activation request based on a signal from manual operating means. The manual operating means may refer, for example, to an emergency opening device (EOD) arranged close to the elevator shaft access or to any other manually operable element.

In an example embodiment, the refuge space control means 100 may be configured to receive the temporary refuge space activation request via a communication connection. This enables, for example, a solution in which the temporary refuge space activation request may be transmitted to the refuge space control means 100 from some controlling entity, for example, a cloud-based node or an application executed in a mobile device. This also enables a solution in which a maintenance person may use his/her mobile device to send the temporary refuge space activation request.

In an example embodiment, the refuge space control means 100 may be configured to reveal hidden manual operating means associated with a landing in response to receiving the temporary refuge space activation request; receive a signal from the manual operating means 100, the signal resulting from an action on the manual operating means by a person at a landing; and change the state of the movement prohibiting means 104 to the active state in response to receiving the signal. This enables a solution in which manual operating means may normally be hidden, and only when the activation request is obtained, the manual operating means may be revealed. This also protects the manual operating means from vandalism and the manual operating means are kept out of sight when they are not needed.

In an example embodiment, the refuge space control means 100 may be configured to start a timer in response to receiving the temporary refuge space activation request; and change the state of the movement prohibiting means 104 to the active state in response to receiving the signal only when receiving the signal before the timer has expired. The use of the timer may provide an additional security feature for accessing the refuge space. For example, if a maintenance person, for some reason, changes his/her mind after operating the manual operating means and does not proceed further, the timer automatically ensures that the state of the movement prohibiting means 104 are changed only if the maintenance person intends to enter the refuge space.

In an example embodiment, the system further comprises a short-range wireless reader 116 arranged at a landing and configured to receive identification data provided by a person at the landing. The refuge space control means 100 may be configured to determine the temporary refuge space activation request based on the identification data from the short-range wireless reader. The short-range wireless reader may be configured, for example, to receive the temporary refuge space activation request via Bluetooth communication (or any other wireless transmission technique) or by reading an identifier associated with a radio frequency identification (RFID) tag. The refuge space control means 100 may make the decision by itself or alternatively it may send the identification data to a separate entity to receive a verification with the identification data. The use of the identification data enables a solution in which access to the temporary refuge space may be restricted only for authorized persons.

In an example embodiment, the movement prohibiting means 104 may be selectively movable between a retracted position to provide the inactive state and a prohibiting position to provide the active state.

1. A triggering device associated with the movement prohibiting means 104 moves to a protective position. This may be caused, for example, by the refuge space control means 100.

2. When the triggering device moves away from the fully retracted state, the refuge space control means 100 monitoring the fully retracted state prevents (for example, opens a safety output) an automatic operation of the elevator.

3. When the triggering device is fully extended, the refuge space control means 100 monitoring the fully extended position disables a power supply of the triggering device and enables landing door (i.e., elevator shaft access) unlocking.

Elevator car and counterweight movement is now limited by a pre-triggered stopping system, and user can open the elevator shaft access to working area. Access door opening is prevented until the triggering device has moved to the protective state. A removal of the triggering device from the protective state may be prevented until no person is detected in the hazard zone and the elevator shaft access opening is prevented. In an example embodiment, the movement prohibiting means 104 may comprise a bi-directional safety gear and an overspeed governor, and a safety gear triggering device and fixed actuation points in the elevator shaft 112.

In an example embodiment, the movement prohibiting means 104 may be mechanically connected to the elevator shaft access locking means 102 such that when the state of the movement prohibiting means 104 changes to the active state, the mechanical connection causes the change of the state of the elevator shaft access locking means 102 to the unlocked state. This may enable a simple and mechanical solution for changing the state of the elevator shaft access locking means 102.

In an example embodiment, the movement prohibiting means 104 may be electrically connected to the elevator shaft access locking means 102 such that when the state of the movement prohibiting means 104 changes to the active state, the electrical connection causes the change of the state of the elevator shaft access locking means 102 to the unlocked state. In this example embodiment, there is no need for a mechanical connection between the movement prohibiting means 104 and the elevator shaft access locking means 102. Instead, the state of the the movement prohibiting means 104 may be detected, for example, based on sensor data, and the state of the movement prohibiting means 104 may then be controlled based on the sensor data.

In an example embodiment, the temporary refuge space is located in the pit of the elevator shaft. In another example embodiment, the temporary refuge space is located at the roof of the elevator car.

In an example embodiment, the refuge space control means 100 may be configured to allow a low-speed elevator operation in the active state of the movement prohibiting means. The movement may be enabled, for example, via a manual user interface operable by a user located in the temporary refuge space.

FIG. 1B illustrates a block diagram of a system for activating a temporary refuge space in an elevator shaft according to an example embodiment.

The system comprises elevator shaft access locking means 102 for controlling access to the temporary refuge space via an elevator shaft access, the elevator shaft access locking means 102 having a locked state in which opening of the elevator shaft access to the temporary refuge space is prevented and an unlocked state in which opening of the elevator shaft access to the temporary refuge space is allowed. The elevator shaft access may refer, for example, to an elevator landing door or doors. The system further comprises movement prohibiting means 104 for prohibiting movement of an elevator car in the elevator shaft, the movement prohibiting means 104 being operable between an inactive state in which the movement of the elevator car 110 is enabled throughout its operating range and an active state in which the movement of the elevator car into the temporary refuge space is prevented. The elevator shaft access locking means 102 may refer, for example, to a lock whose locking state can be remotely controlled.

The system further comprises refuge space control means 100 associated with the elevator shaft access locking means 102 and the and the movement prohibiting means 104. The refuge space control means 100 may be configured to, in response to determining a temporary refuge space activation request, change 101 the state of the movement prohibiting means 104 to the active state. When the state of the movement prohibiting means 104 has been changed, the movement prohibiting means 104 may be configured to send 103 an indication to the refuge space control means 100 that its state has changed to the active state. According to an embodiment, the change of the state of the movement prohibiting means causes a status change of a safety contact belonging to the refuge space control means 100. In response to the indication 103, the refuge space control means 100 may be configured to cause a change of the state of the elevator shaft access locking means 102 to the unlocked state to enable access to the temporary refuge space in the elevator shaft via the elevator shaft access. The refuge space control means 100 may refer, for example, to hardware and/or software elements implementing the functionality relating to the refuge space control means 100.

FIG. 1C illustrates a block diagram of a system for deactivating an activated temporary refuge space in an elevator shaft according to an example embodiment.

The system comprises elevator shaft access locking means 102 for controlling access to the temporary refuge space via an elevator shaft access, the elevator shaft access locking means 102 having a locked state in which opening of the elevator shaft access to the temporary refuge space is prevented and an unlocked state in which opening of the elevator shaft access to the temporary refuge space is allowed, wherein when the temporary refuge space is activated, the elevator shaft access locking means are in the unlocked state. The elevator shaft access may refer, for example, to an elevator landing door or doors. The system further comprises movement prohibiting means 104 for prohibiting movement of an elevator car in the elevator shaft, the movement prohibiting means 104 being operable between an inactive state in which the movement of the elevator car is enabled throughout its operating range and an active state in which the movement of the elevator car into the temporary refuge space is prevented, wherein when the temporary refuge space is activated, the movement prohibiting means 104 are in the active state. The system further comprises refuge space deactivation means 106 for providing deactivation information associated with the temporary refuge space.

The system further comprises refuge space control means 100 associated with the elevator shaft access locking means 102, the movement prohibiting means 104 and the refuge space deactivation means 106. The refuge space control means 100 may be configured to receive refuge space deactivation information from the refuge space deactivation means 106; determine that the elevator shaft access is closed; change the state of the elevator shaft access locking means 102 to the locked state; cause a change of the state of the movement prohibiting means 104 to the inactive state; and generate a signal indicating that the temporary refuge space has been deactivated.

In an example embodiment, the deactivation information associated with the temporary refuge space comprises information about the presence of the person in the temporary refuge space. The refuge space control means 100 are configured to determine, based the refuge space deactivation information, that the temporary refuge space is empty. The refuge space deactivation means 106 may comprise, for example, at least one of a camera, an infrared sensor and a pressure mat arranged in the temporary refuge space for indicating the presence or absence of the person in the temporary refuge space. When using a camera, a pressure mat or an infrared sensor, a person in the temporary refuge space may be automatically detected without any user actions.

In an example embodiment, the refuge space deactivation means 106 comprises a first control function associated with the temporary refuge space and a second control function associated with the outside the elevator shaft. The first control function may refer, for example, to a pressure sensor, a camera, a manual switch, a radio frequency (RF) reader etc. providing information associated with the temporary refuge space. The refuge space control means 100 may be configured to receive first temporary refuge space deactivation information from the first control function, the first temporary refuge space deactivation information initiating the deactivation of the temporary refuge space; and receive second temporary refuge space deactivation information from the second control function, the second temporary refuge space deactivation information confirming the deactivation of the temporary refuge space. In this example, the deactivation may be split into two phases, and two separate actions needs to be identified before the temporary refuge space is deactivated. As the first action is initiated based on information associated with the temporary refuge space, there can be seen an intention to deactivate the temporary refuge space. Then, the deactivation of the temporary refuge space is confirmed only when obtaining a confirmation for the deactivation outside the temporary refuge space. This provides a verification that the temporary refuge space is empty.

In an example embodiment, the refuge space control means 100 may be configured to start a timer in response to receiving the first temporary refuge space deactivation information; determine, whether the second temporary refuge space deactivation information is received before the timer expires; and generate the signal indicating that the temporary refuge space has been deactivated only, when the second temporary refuge space deactivation information is received before the timer expires. The use of the timer provides additional security for deactivating the temporary refuge space. If the timer expires before the second temporary refuge space deactivation information is received, the person in the temporary refuge space has to restart the deactivation process.

In an example embodiment, the refuge space deactivation means 106 comprises a first control function associated with the temporary refuge space and a second control function associated with the outside the elevator shaft. The refuge space control means 100 may be configured to receive first temporary refuge space deactivation information from the second control function, the first temporary refuge space deactivation information initiating the deactivation of the temporary refuge space; receive second temporary refuge space deactivation information from the first control function; and determine, based on the second temporary refuge space deactivation information, that the temporary refuge space is empty. In other words, in this example, the deactivation of the temporary refuge space may be started outside the temporary refuge space. Then, after starting the deactivation of the temporary refuge space outside the temporary refuge space, it is made sure, based on the second temporary refuge space deactivation information from the first control function, that the temporary refuge space is empty. Even if the deactivation of the temporary refuge space is initiated outside the temporary refuge space, a verification that the temporary refuge space is empty is still needed.

In an example embodiment, the first control function may comprise at least one of the following: a manually operable control element configured to enable a manual operation performed by a person; a short-range wireless reader configured to receive identification data provided by the person at the temporary refuge space; a camera configured to provide an indication of the absence of the person in the temporary refuge space; an infrared sensor configured to provide an indication of the absence of the person in the temporary refuge space; and a pressure sensor configured to provide an indication of the absence of the person in the temporary refuge space. In other words, the first control function may refer to some function, for example, a pit reset button, that the maintenance person needs to manually operate or to short-range wireless reader to which the maintenance person needs to show his/her identification tag. Alternatively, the first control function may provide information automatically without (intentional) manual actions from the person. For example, an infrared sensor, a camera or a pressure sensor or mat may automatically provide an indication to the refuge space control means 100 that the maintenance person has left the temporary refuge space. This may then constitute the first temporary refuge space deactivation information.

In an example embodiment, the second control function comprises at least one of the following: a manually operable control element configured to enable a manual operation performed by a person at a landing; a short-range wireless reader configured to receive identification data provided by the person at the landing; a camera based recognition system; and a camera based reader configured to read identification data provided by the person at the landing. Depending on the embodiment, the second control function may be used either to initiate the deactivation of the temporary refuge space or to confirm the deactivation of the temporary refuge space. In either case, various solutions and implementations may be used as the second control function. For example, the manually operable control element may refer, for example, to an emergency opening device (EOD) arranged close to the elevator shaft access. Alternatively, the maintenance person may use a remotely readable tag, for example, an RFID tag, for confirming that he/she has left the temporary refuge space. In an example embodiment, the remotely readable tag may be used for providing both the deactivation information initiating the deactivation of the temporary refuge space and the deactivation information confirming the deactivation of the temporary refuge space. As the same the remotely readable tag is used both in entering the temporary refuge space and leaving the temporary refuge space, a confirmation is received that the same person performed both actions.

In an example embodiment, the movement prohibiting means 104 may be mechanically connected to the elevator shaft access locking means 102 such that when the state of the movement prohibiting means 104 changes to the inactive state, the mechanical connection causes the change of the state of the elevator shaft access locking means 102 to the locked state. This may enable a simple and mechanical solution for changing the state of the elevator shaft access locking means 102.

In an example embodiment, the movement prohibiting means 104 may be electrically connected to the elevator shaft access locking means 102 such that when the state of the movement prohibiting means 104 changes to the inactive state, the mechanical connection causes the change of the state of the elevator shaft access locking means 102 to the locked state. In this example embodiment, there is no need for a mechanical connection between the movement prohibiting means 104 and the elevator shaft access locking means 102. Instead, the state of the the movement prohibiting means 104 may be detected, for example, based on sensor data, and the state of the movement prohibiting means 104 may then be controlled based on the sensor data.

In an example embodiment, a system may comprise the system for activating the temporary refuge space in the elevator shaft, as discussed relating to FIG. 1A and the system for deactivating the activated temporary refuge space in the elevator shaft, as discussed relating to FIG. 1C.

FIG. 1D illustrates an elevator system according to an example embodiment. The elevator system comprises an elevator car 110 disposed in and movable in an elevator shaft 112. A temporary refuge space 108 may be arranged in the pit of the elevator shaft 112. In another example embodiment, the temporary refuge space 108 may be arranged at the roof of the elevator car 110. The refuge space control means 100 are communicatively connected to the movement prohibiting means 104 and the elevator shaft access locking means 102 associated with an elevator shaft access 114 at a landing 118. The elevator system may further comprise the refuge space deactivation means 106 communicatively connected to the refuge space control means 100. In an example embodiment, the elevator system may comprise only the system for activating the temporary refuge space 108 in the elevator shaft 112 illustrated in FIG. 1A. In another example embodiment, the elevator system may comprise only the system for deactivating an activated temporary refuge space 118 in the elevator shaft 112 illustrated in FIG. 1C. Yet in another example embodiment, the elevator system may comprise both systems.

The exemplary embodiments and aspects of the invention can be included within any suitable device, for example, including, servers, workstations, capable of performing the processes of the exemplary embodiments. The exemplary embodiments may also store information relating to various processes described herein.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A system for activating a temporary refuge space in an elevator shaft, the system comprising:
elevator shaft access locking means for controlling access to the temporary refuge space via an elevator shaft access, the elevator shaft access locking means having a locked state in which opening of the elevator shaft access to the temporary refuge space is prevented and an unlocked state in which opening of the elevator shaft access to the temporary refuge space is allowed;
movement prohibiting means for prohibiting movement of an elevator car in the elevator shaft, the movement prohibiting means being operable between an inactive state in which the movement of the elevator car is enabled throughout its operating range and an active state in which the movement of the elevator car into the temporary refuge space is prevented;
refuge space control means associated with the elevator shaft access locking means and the movement prohibiting means;
wherein the refuge space control means are configured to:
in response to determining a temporary refuge space activation request, change the state of the movement prohibiting means to the active state, and in response to changing the state of the movement prohibiting means to the active state, cause a change of the state of the elevator shaft access locking means to the unlocked state to enable access to the temporary refuge space in the elevator shaft via the elevator shaft access.

2. The system of claim 1, wherein the refuge space control means are configured to determine the temporary refuge space activation request based on a signal from manual operating means.

3. The system of claim 1, wherein the refuge space control means are configured to receive the temporary refuge space activation request via a communication connection.

4. The system of claim 3, wherein the refuge space control means are configured to:
reveal hidden manual operating means associated with a landing in response to receiving the temporary refuge space activation request;
receive a signal from the manual operating means, the signal resulting from an action on the manual operating means by a person at a landing; and
change the state of the movement prohibiting means to the active state in response to receiving the signal.

5. The system of claim 4, wherein the refuge space control means are configured to:
start a timer in response to receiving the temporary refuge space activation request; and
change the state of the movement prohibiting means to the active state in response to receiving the signal only when receiving the signal before the timer has expired.

6. The system of claim 1, further comprising a short-range wireless reader arranged at a landing and configured to receive identification data provided by a person at the landing, wherein the refuge space control means are configured to:
determine the temporary refuge space activation request based on the identification data from the short-range wireless reader.

7. The system of claim 1, wherein the movement prohibiting means are selectively movable between a retracted position to provide the inactive state and a prohibiting position to provide the active state.

8. The system of claim 1, wherein the movement prohibiting means are mechanically connected to the elevator shaft access locking means such that when the state of the movement prohibiting means changes to the active state, the mechanical connection causes the change of the state of the elevator shaft access locking means to the unlocked state.

9. The system of claim 1, wherein the movement prohibiting means are electrically connected to the elevator shaft access locking means such that when the state of the movement prohibiting means changes to the active state, the electrical connection causes the change of the state of the elevator shaft access locking means to the unlocked state.

10. The system of claim 1, wherein the temporary refuge space is located in the pit of the elevator shaft.

11. The system of claim 1, wherein the temporary refuge space is located at the roof of the elevator car.

12. The system of claim 1, wherein the refuge space control means are configured to allow a low-speed elevator operation in the active state of the movement prohibiting means.

13. A system for deactivating an activated temporary refuge space in an elevator shaft, the system comprising:
elevator shaft access locking means for controlling access to the temporary refuge space via an elevator shaft access, the elevator shaft access locking means having a locked state in which opening of the elevator shaft access to the temporary refuge space is prevented and an unlocked state in which opening of the elevator shaft access to the temporary refuge space is allowed, wherein when the temporary refuge space is activated, the elevator shaft access locking means are in the unlocked state;
movement prohibiting means for prohibiting movement of an elevator car in the elevator shaft, the movement prohibiting means being operable between an inactive state in which the movement of the elevator car is enabled throughout its operating range and an active state in which the movement of the elevator car into the temporary refuge space is prevented, wherein when the temporary refuge space is activated, the movement prohibiting means are in the active state;
refuge space deactivation means for providing deactivation information associated with the temporary refuge space; and
refuge space control means associated with the elevator shaft access locking means, the movement prohibiting means and refuge space deactivation means;
wherein the refuge space control means are configured to:
receive refuge space deactivation information from the refuge space deactivation means;
determine that the elevator shaft access is closed;
change the state of the elevator shaft access locking means to the locked state;
cause a change of the state of the movement prohibiting means to the inactive state; and
generate a signal indicating that the temporary refuge space has been deactivated.

14. The system of claim 13, wherein the deactivation information associated with the temporary refuge space comprises information about the presence of the person in the temporary refuge space, and wherein the refuge space control means are configured to:
determine, based the refuge space deactivation information, that the temporary refuge space is empty.

15. The system of claim 14, wherein the refuge space monitoring means comprises at least one of a camera, an infrared sensor and a pressure mat arranged in the temporary refuge space for indicating the presence or absence of the person in the temporary refuge space.

16. The system of claim 13, wherein the refuge space deactivation means comprises a first control function associated with the temporary refuge space and a second control function associated with the outside the elevator shaft;
wherein the refuge space control means are configured to:
receive first temporary refuge space deactivation information from the first control function, the first temporary refuge space deactivation information initiating the deactivation of the temporary refuge space; and
receive second temporary refuge space deactivation information from the second control function, the second temporary refuge space deactivation information confirming the deactivation of the temporary refuge space.

17. The system of claim 16, wherein the refuge space control means are configured to:
start a timer in response to receiving the first temporary refuge space deactivation information;
determine, whether the second temporary refuge space deactivation information is received before the timer expires; and
generate the signal indicating that the temporary refuge space has been deactivated only, when the second temporary refuge space deactivation information is received before the timer expires.

18. The system of claim 13, wherein the refuge space deactivation means comprises a first control function associated with the temporary refuge space and a second control function associated with the outside the elevator shaft;
wherein the refuge space control means are configured to:
receive first temporary refuge space deactivation information from the second control function, the first temporary refuge space deactivation information initiating the deactivation of the temporary refuge space;
receive second temporary refuge space deactivation information from the first control function; and
determine, based on the second temporary refuge space deactivation information, that the temporary refuge space is empty.

19. The system of claim 16, wherein the first control function comprises at least one of the following:
a manually operable control element configured to enable a manual operation performed by a person;
a short-range wireless reader configured to receive identification data provided by the person at the temporary refuge space;
a camera configured to provide an indication of the absence of the person in the temporary refuge space;
an infrared sensor configured to provide an indication of the absence of the person in the temporary refuge space; and
a pressure sensor configured to provide an indication of the absence of the person in the temporary refuge space.

20. The system of claim 16, wherein the second control function comprises at least one of the following:
a manually operable control element configured to enable a manual operation performed by a person at a landing;
a short-range wireless reader configured to receive identification data provided by the person at the landing;
a camera based recognition system; and
a camera based reader configured to read identification data provided by the person at the landing.

21. The system of claim 13, wherein the movement prohibiting means are mechanically connected to the elevator shaft access locking means such that when the state of the movement prohibiting means changes to the inactive state, the mechanical connection causes the change of the state of the elevator shaft access locking means to the locked state.

22. The system of claim 13, wherein the movement prohibiting means are electrically connected to the elevator shaft access locking means such that when the state of the movement prohibiting means changes to the inactive state, the electrical connection causes the change of the state of the elevator shaft access locking means to the locked state.

23. An elevator system, comprising:
an elevator car disposed in and movable in an elevator shaft; and
a system of claim 1.
